(19) United States
(12) Patent Application Publication
(10) Pub. No.: US 2021/0174815 A1
(43) Pub. Date: Jun. 10, 2021

(54) QUANTIZATION METHOD OF LATENT VECTOR FOR AUDIO ENCODING AND COMPUTING DEVICE FOR PERFORMING THE METHOD

(71) Applicant: Electronics and Telecommunications Research Institute, Daejeon (KR)

(72) Inventors: Seung Kwon BEACK, Daejeon (KR); Jooyoung LEE, Daejeon (KR); Jongmo SUNG, Daejeon (KR); Mi Suk LEE, Daejeon (KR); Tae Jin LEE, Daejeon (KR); Woo-taek LIM, Daejeon (KR); Seunghyun CHO, Daejeon (KR); Jin Soo CHOI, Daejeon (KR)

(73) Assignee: Electronics and Telecommunications Research Institute, Daejeon (KR)

(21) Appl. No.: 17/112,480

(22) Filed: Dec. 4, 2020

(30) Foreign Application Priority Data
Dec. 5, 2019 (KR) 10-2019-0160879

(51) Int. Cl. G10L 19/038; G10L 25/30; G10L 19/028; G10L 19/24; G06N 3/02

(52) U.S. Cl. CPC G10L 19/038; G10L 25/30; G06N 3/02; G10L 19/24; G10L 19/028

(57) ABSTRACT

Disclosed are a quantizing method for a latent vector and a computing device for performing the quantization method. A quantizing method of a latent vector includes performing information shaping on the latent vector resulting from reduction in a dimension of an input signal using a target neural network; clamping a residual signal of the latent vector derived based on the information shaping; performing resealing on the clamped residual signal; and performing quantization on the resealed residual signal.

### CROSS-REFERENCE TO RELATED APPLICATION(S)

This application claims the benefit of Korean Patent Application No. 10-2019-0160879, filed on Dec. 5, 2019, in the Korean Intellectual Property Office, the disclosure of which is incorporated herein by reference.

### BACKGROUND

### 1. Field of the Invention

One or more example embodiments relate to a quantizing method of a latent vector for to audio encoding and a computing device for performing the quantization method.

### 2. Description of the Related Art

A method of reducing the dimension of data based on neural networks such as auto encoders (AE) is being used. However, although the result of finally reducing the dimension contains a large amount of information, a method of more efficiently reducing the amount of information of the result of reducing the dimension is required.

### SUMMARY

According to an aspect, there is provided a method and apparatus capable of effectively quantizing a latent vector derived from a target neural network for audio encoding/decoding such as an autoencoder.

According to an aspect, there is provided a method and apparatus for effectively reducing the amount of information of a latent vector by deriving and quantizing a residual signal by applying a scale factor predicted from a helper neural network to a latent vector derived from a target neural network.

According to an aspect, there is provided a quantization method of a latent vector comprises performing information shaping on the latent vector resulting from reduction in a dimension of an input signal using a target neural network; clamping a residual signal of the latent vector derived based on the information shaping; performing resealing on the clamped residual signal; and performing quantization on the resealed residual signal.

The performing the information shaping may perform information shaping by applying a scale factor predicted by a helper neural network to the latent vector.

The performing the information shaping may perform scaling down the latent vector by dividing the latent vector using the scale vector and determines the residual signal of the latent vector.

The clamping the residual signal of the latent vector may perform clipping by applying a predetermined minimum value and a predetermined maximum value to the residual signal of the latent vector derived from the information shaping.

The performing the resealing may adjust a scale of a clamped residual signal by applying a quantization resolution to the clamped residual signal.

The quantization resolution of the latent vector is adjusted according to a bit rate.

The performing the quantization may quantize a residual signal by applying random noise to the resealed residual signal.

According to an aspect, there is provided a computing device for performing a quantization method of a latent vector comprises one or more processor configured to perform information shaping on the latent vector resulting from reduction in a dimension of an input signal using a target neural network; clamp a residual signal of the latent vector derived based on the information shaping; perform resealing on the clamped residual signal; and perform quantization on the resealed residual signal.

The processor may perform information shaping by applying a scale factor predicted by a helper neural network to the latent vector.

The processor may perform scaling down the latent vector by dividing the latent vector using the scale vector and determines the residual signal of the latent vector.

The processor may perform clipping by applying a predetermined minimum value and a predetermined maximum value to the residual signal of the latent vector derived from the information shaping.

The processor may adjust a scale of a clamped residual signal by applying a quantization resolution to the clamped residual signal.

The quantization resolution of the latent vector is adjusted according to a bit rate.

The processor may quantize a residual signal by applying random noise to the resealed residual signal.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates a structure of a neural network for encoding and decoding audio data according to an embodiment of the present invention.

FIG. 2 illustrates a target neural network and a helper neural network according to an embodiment of the present invention.

FIG. 3 illustrates is a diagram for a quantization process according to an embodiment of the present invention.

FIG. 4 illustrates a process of deriving a probability according to an embodiment of the present invention.

FIG. 5 illustrates diagram for a result of varying probability based on a scale factor according to an embodiment of the present invention.

FIG. 6 illustrates a flowchart for a quantization process according to an embodiment of the present invention.

### DETAILED DESCRIPTION

Hereinafter, example embodiments will be described in detail with reference to the accompanying drawings. The scope of the right, however, should not be construed as limited to the example embodiments set forth herein. Like reference numerals in the drawings refer to like elements based onout the present disclosure.

Various modifications may be made to the example embodiments. Here, the examples are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

The terminology used herein is for the purpose of describing particular embodiments only and is not intended to be limiting. As used herein, the singular forms are intended to include the plural forms as well, unless the context clearly indicates otherwise. It will be further understood that the terms “comprise” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

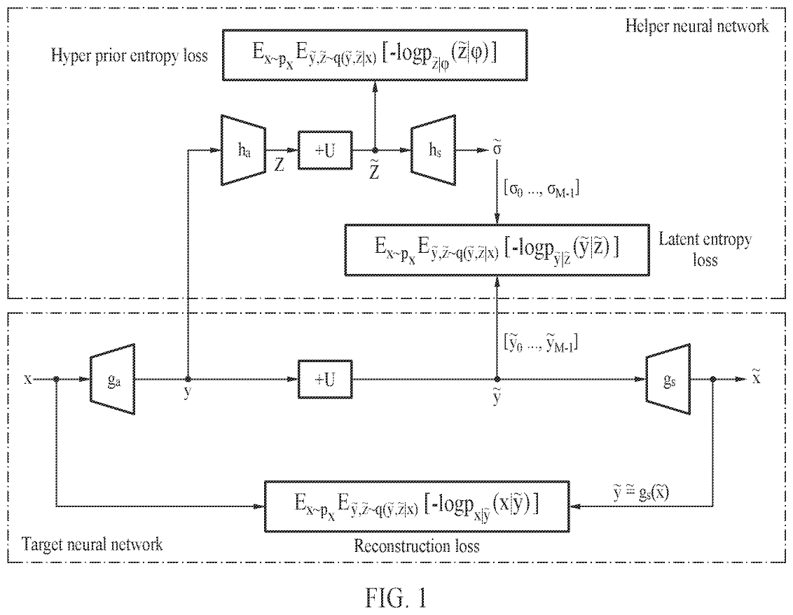

FIG. 1 illustrates a structure of a neural network for encoding and decoding audio data according to an embodiment of the present invention.

Referring to FIG. 1, a target neural network for restoring the input signal by reducing the dimension of the input signal and increasing the dimension of the input signal with the reduced dimension is shown. And, a helper neural network that provides information necessary to quantize y, which is an intermediate product of the target neural network, is shown. The input signal x is converted to y based on the gₐ function.

y may be a latent vector whose dimension is reduced based on a gₐ function composed of a plurality of layers in the input signal x. For example, when the input signal x is an audio signal, the latent vector may correspond to a result of encoding the audio signal with a reduced dimension. And, y is quantized based on the +U block. At this time, the U+ block is quantized by generating uniform random noise from −0.5 to 0.5 and then applying it to the latent vector y. By applying random noise like a U+ block, it is possible to model the degree of noise generated when the latent vector y is converted into an integer value based on an operation such as round.

However, −0.5 to 0.5 representing random noise means that only the quantization process in which the latent vector y is transformed into an integer type is modeled. In order to train the target neural network of FIG. 1, two loss terms may be considered.

The first loss term relates to the loss for general distortion, and is the reconstruction loss for the difference between the input signal x and the final signal of the target neural network \tilde{x}. The second term relates to the amount of bits, and is regarded as a loss term by measuring the amount of entropy.

Therefore, the final loss function for training the target neural network is expressed as Loss=entropy+α*distortion. The two terms described above are connected by an arbitrary constant α. The loss function above may be expressed by Equation 1 below.

In the present invention, a process of deriving entropy and quantizing y will be described in detail.

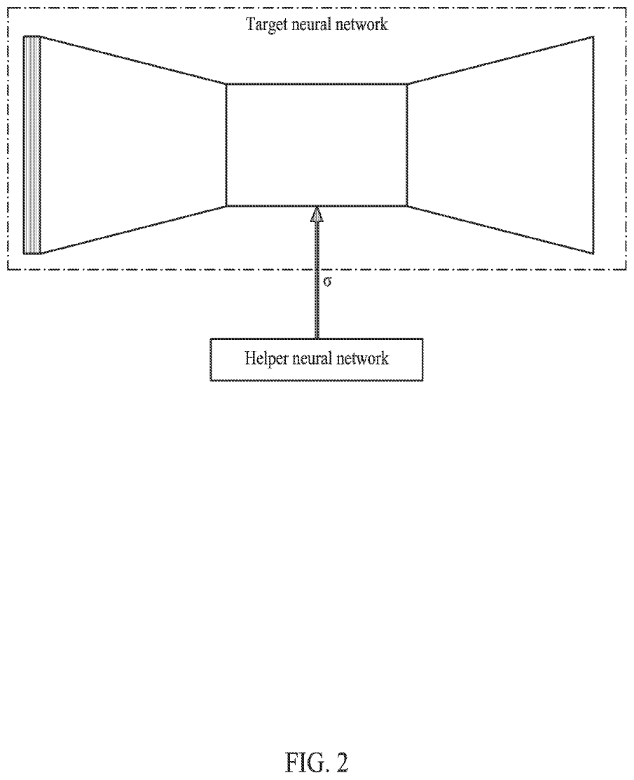

FIG. 2 illustrates a target neural network and a helper neural network according to an embodiment of the present invention.

The degree to which the amount of information is reduced may vary depending on how to express the latent vector y derived based on the target neural network according to an embodiment of the present invention.

The scale of y mentioned in FIG. 1 is adjusted based on the scale factor σ received from the helper neural network. The probability for entropy coding y whose scale is adjusted in this way is determined based on Equation 2 below.

The helper neural network corresponds to the hyper-prior, and receives the latent vector y derived from the target neural network and outputs the scale factor σ.

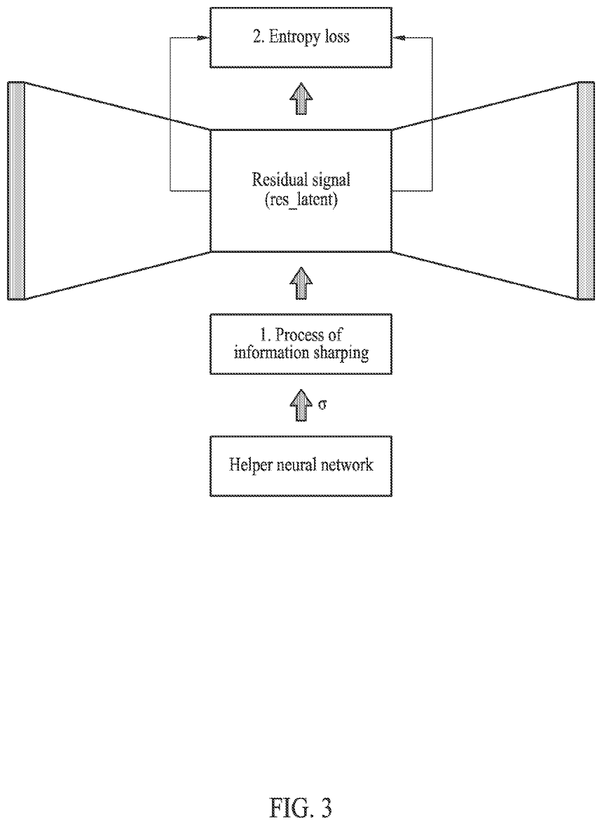

FIG. 3 illustrates is a diagram for a quantization process according to an embodiment of the present invention.

In the first step, the computing device performs information shaping on the entropy model using the scale factor received from the helper neural network.

According to an embodiment of the present invention, instead of inputting into a +U to block (noise representation) that applies random noise to the latent vector y derived from the target neural network, the computing device predicts σ, which is a scale factor for the latent vector y. and performs information shaping by dividing the vector y by the scale factor σ received from the helper neural network. At this time, if the scale factor σ is optimally modeled,

$${y}_{res} = \frac{y}{σ}$$

derived based on information shaping swill be close to 1.

In the second process, the computing device applies a random noise (noise representation) by applying a +U block to yᵣₑₛ, which is a result of dividing the latent vector y by the scale factor σ. The noise representation process applying random noise is applied to

$$\frac{y}{σ}$$

derived from information shaping, but when the latent vector y is less than 1, noise representation is performed on log

$$( \frac{y}{σ} ) .$$

The procedure may be expressed as yᵣₑₛ=log₂(y)−log₂(σ).

Applying random noise, such as performing noise representation, means that the computing device performs quantization. The yᵣₑₛ derived based on information shaping is quantized based on the noise representation to obtain [symbol] . In order to represent yᵣₑₛ with more bits, a larger scale factor may be applied, and thus the resolution of yᵣₑₛ may increase.

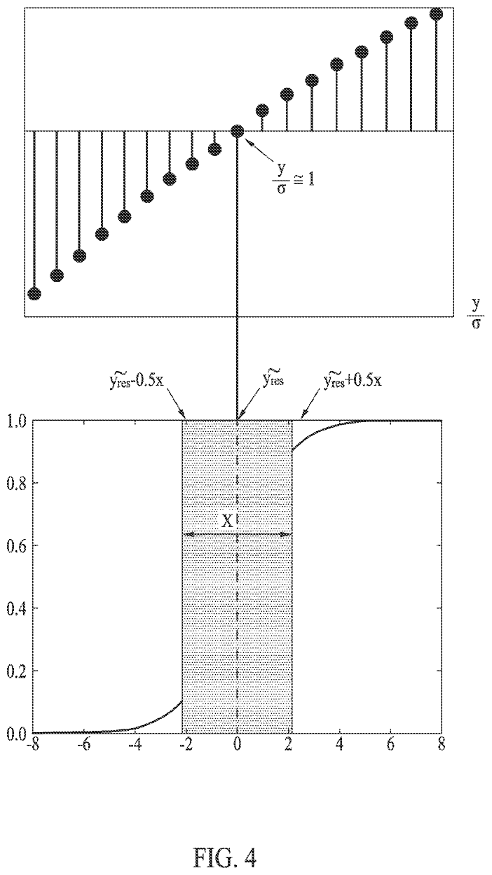

FIG. 4 illustrates a process of deriving a probability according to an embodiment of the present invention.

FIG. 4 illustrates an assumption for deriving a probability for yᵣₑₛ. If

$$\frac{y}{σ}$$

is close to 1 and the log result of yᵣₑₛ is expressed as 0, the probability may be derived based on an error function of −0.5 to +0.5 based on yᵣₑₛ. In FIG. 4, an area having an interval of x is a section corresponding to a probability. By integrating this region, the probability for actually encoding yᵣₑₛ may be derived.

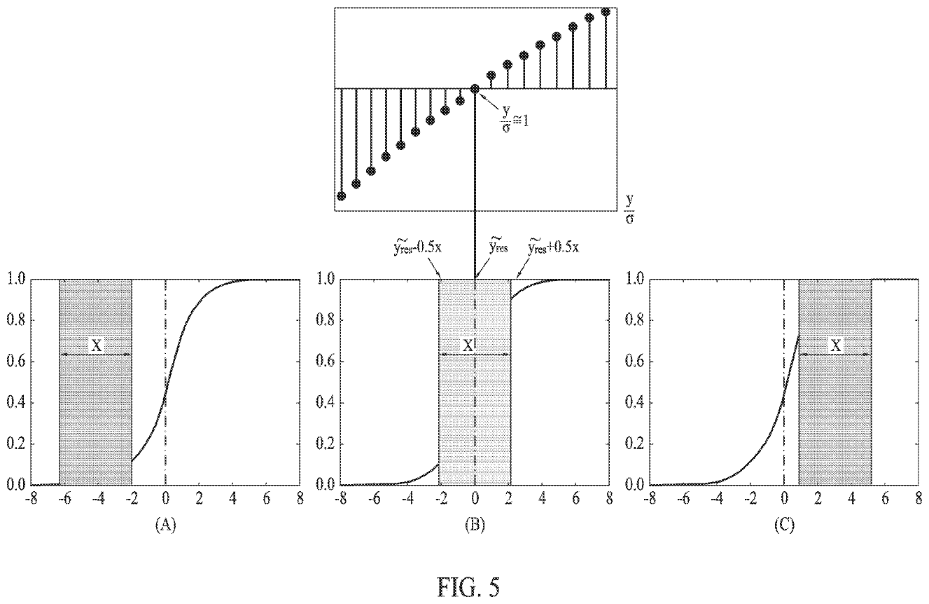

FIG. 5 illustrates diagram for a result of varying probability based on a scale factor according to an embodiment of the present invention.

If, unlike FIG. 4, y/σ is not close to 1, the same probability as A of FIG. 5 or C of FIG. 5 may be derived. Regardless of y/σ, the probability interval has a constant period between [symbol] −0.5x and [symbol] +0.5x.

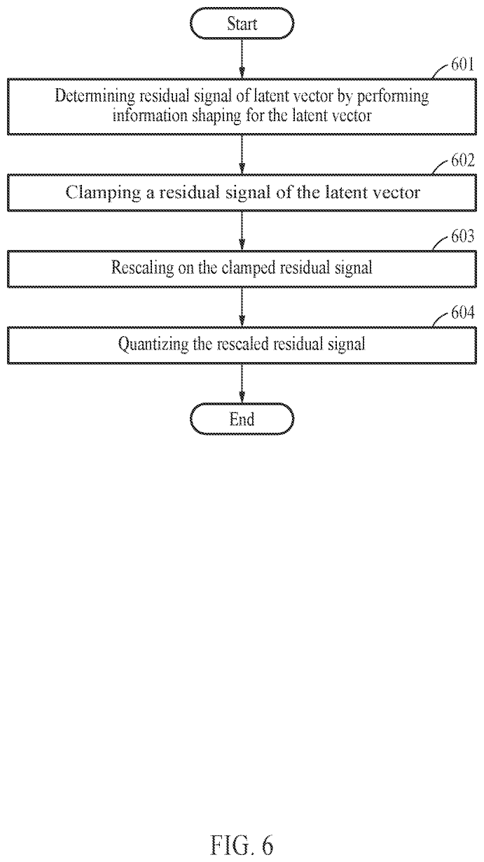

FIG. 6 illustrates a flowchart for a quantization process according to an embodiment of the present invention.

In step 601 of FIG. 6, the computing device may perform information shaping on the latent vector using the latent vector y to be derived from the target neural network and the scale factor σ predicted from the helper neural network. The information shaping is

$$\frac{y}{σ} ,$$

which means the residual signal yᵣₑₛ in which the latent vector y is scaled down. The residual signal yᵣₑₛ is derived by dividing the latent vector y by a scale factor, or as log(y+EPS)−log(sigma+EPS) in the log domain. EPS is a very small number so that the log is not zero.

In step 602 of FIG. 6, the computing device may perform clamping on the information-shaped latent vector (the residual signal of the latent vector). Here, processing the clamping means clipping the information-shaped. latent vector to a predetermined minimum value (min) and a predetermined maximum value (max). This is to limit the dynamic range for quantization.

In step 603 of FIG. 6, the computing device may perform resealing to adjust the scale of the clamped residual signal. The resealing process is the result of dividing the quantization resolution by the clamped residual signal. If the quantization resolution is 1, the residual signal is is quantized as it is. And, if the quantization resolution is 0.5, the residual signal is quantized by increasing twice. The quantization resolution is adjusted according to the bit rate.

In an embodiment of the present invention, yᵣₑₛ, which is a residual signal of a latent vector, is subjected to quantization, and the quantized result may be converted into a bitstream.

In step 604 of FIG. 6, the computing device may quantize the resealed residual signal. The quantization process refers to a noise representation in which random noise is applied to the residual signal.

In order to restore the quantized result back to the original latent vector, a scale factor and a quantization resolution (quantization_resolution) are applied to the quantized result. If the residual signal of the latent vector is derived by applying the log, the quantized result may be restored to the latent vector based on exp{res_noise_representation*quantization_resolution+log(sigma+EPS)}.

The components described in the example embodiments may be implemented by hardware components including, for example, at least one digital signal processor (DSP), processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a to recording medium. The components, the functions, and the processes described in the example embodiments may be implemented by a combination of hardware and software.

The apparatus described herein may be implemented using a hardware component, a software component and/or a combination thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various to operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable is media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A quantization method of a latent vector, comprising:
performing information shaping on the latent vector resulting from reduction in a dimension of an input signal using a target neural network;
clamping a residual signal of the latent vector derived based on the information shaping;
performing resealing on the clamped residual signal; and
performing quantization on the resealed residual signal.

2. The method of claim 1, wherein the performing the information shaping to performs information shaping by applying a scale factor predicted by a helper neural network to the latent vector.

3. The method of claim 1, wherein the performing the information shaping performs scaling down the latent vector by dividing the latent vector using the scale vector and is determines the residual signal of the latent vector.

4. The method of claim 1, wherein the clamping the residual signal of the latent vector performs clipping by applying a predetermined minimum value and a predetermined maximum value to the residual signal of the latent vector derived from the information shaping.

5. The method of claim 1, wherein the performing the resealing adjusts a scale of a clamped residual signal by applying a quantization resolution to the clamped residual signal.

6. The method of claim 5, wherein the quantization resolution of the latent vector is adjusted according to a bit rate.

7. The method of claim 1, wherein the performing the quantization quantizes a residual signal by applying random noise to the resealed residual signal.

8. A computing device for performing a quantization method of a latent vector, comprising:
one or more processor configured to:
perform information shaping on the latent vector resulting from reduction in a dimension of an input signal using a target neural network;
clamp a residual signal of the latent vector derived based on the information shaping;
perform resealing on the clamped residual signal; and
perform quantization on the resealed residual signal.

9. The computing device of claim 8, wherein the processor performs information shaping by applying a scale factor predicted by a helper neural network to the latent vector.

10. The computing device of claim 8, wherein the processor performs scaling down the latent vector by dividing the latent vector using the scale vector and determines the residual signal of the latent vector.

11. The computing device of claim 8, wherein the processor performs clipping by applying a predetermined minimum value and a predetermined maximum value to the residual signal of the latent vector derived from the information shaping.

12. The computing device of claim 8, wherein the processor adjusts a scale of a clamped residual signal by applying a quantization resolution to the clamped residual signal.

13. The computing device of claim 12, wherein the quantization resolution of the latent vector is adjusted according to a bit rate.

14. The computing device of claim 8, wherein the processor quantizes a residual signal by applying random noise to the resealed residual signal.
